(19) United States
(12) Patent Application Publication
(10) Pub. No.: US 2021/0200067 A1
(43) Pub. Date: Jul. 1, 2021

(54) LENS MOUNT, PHOTOGRAPHING APPARATUS, PHOTOGRAPHING SYSTEM AND MOVABLE OBJECT

(71) Applicant: SZ DJI TECHNOLOGY CO., LTD., Shenzhen (CN)

(72) Inventor: Futoshi IINUMA, Shenzhen (CN)

(73) Assignee: SZ DJI TECHNOLOGY CO., LTD., Shenzhen (CN)

(21) Appl. No.: 17/198,115

(22) Filed: Mar. 10, 2021

Related U.S. Application Data
(63) Continuation of application No. PCT/CN2020/075072, filed on Feb. 13, 2020.

(30) Foreign Application Priority Data
Feb. 25, 2019 (JP) 2019-032143

(51) Int. Cl. G03B 17/14; G02B 7/14; G03B 17/56

(52) U.S. Cl. CPC G03B 17/14; G03B 17/561; G02B 7/14

(57) ABSTRACT

A compact lens mount capable of securely holding an interchangeable lens by using a photographing apparatus is disclosed is disclosed. The lens mount includes: a ring-shaped fixing member fixed to the photographing apparatus; a ring-shaped movable member, having a second protrusion portion engaged with a first protrusion portion of the interchangeable lens; and a force application member applying a force to the movable member towards the fixing member. The fixing member including a first surface contacting the movable member, the movable member including a second surface contacting the fixing member, where at least one of the first surface or the second surface is an inclined surface. The movable member rotates in a first direction along the inclined surface, and the second protrusion portion may press the first protrusion portion towards the image-taking-surface side, to fix the interchangeable lens to the photographing apparatus.

### RELATED APPLICATIONS

This application is a continuation application of PCT application No. PCT/CN2020/075072, filed on Feb. 13, 2020, which claims priority of Japanese application No. JP 2019-032143 filed on Feb. 25, 2019 and the content of which is incorporated herein by reference in its entirety.

### TECHNICAL FIELD

The present disclosure relates to a lens mount, a photographing apparatus, a photographing system, and a movable object.

### BACKGROUND

Reference 1 disclosed that an internal thread member of a fixing mount member and an external thread member of a movable mount member are threaded together, so that a protrusion member of the movable mount member moves along an optical axis direction with rotation of the movable mount member.

### PRIOR ART LITERATURE

Reference 1: Japanese Patent Publication No. 2013-218149.

### BRIEF SUMMARY

### Technical Problem to be Resolved

Reference 1 provides a lens mount with a screw structure, which increases a thickness in an optical axis direction. Therefore, there is a need to design a smaller lens mount, which is able to securely holding an interchangeable lens through a photographic apparatus.

### Technical Solutions

According to some aspects of the present disclosure, a lens mount for detachably connecting an interchangeable lens to a photographing apparatus is provided, including: a ring-shaped fixing member to fix to a photographing apparatus, including a first surface; a ring-shaped movable member including a second protrusion portion engageable with a first protrusion portion of an interchangeable lens, and a second surface rotatably contacting the first surface; and a force application member, applying a force to the movable member towards the fixing member, where at least one of the first surface or the second surface includes an inclined surface having an angle with respect to a rotation direction of the movable member, and when the lens mount is fixed to the photographing apparatus, the ring-shaped movable member is closer to an image-taking-surface side of the photographing apparatus than the fixing member, the force application member is closer to the image-taking-surface side than the movable member, and when the movable member rotates in a first direction of the rotation direction, the movable member slides along the inclined surface and moves towards the image-taking-surface side, and the second protrusion portion presses the first protrusion portion towards the image-taking-surface side, thereby fixing the interchangeable lens to the photographing apparatus.

According to some aspects of the present disclosure, a photographing system is provided, including: a photographing apparatus including an image sensor; and a lens mount, including: a ring-shaped fixing member fixed to the photographing apparatus, including a first surface, a ring-shaped movable member, including: a second protrusion portion engageable with a first protrusion portion of an interchangeable lens, and a second surface rotatably contacting the first surface, and a force application member, applying a force to the movable member towards the fixing member, where at least one of the first surface or the second surface includes an inclined surface having an angle with respect to a rotation direction of the movable member, and when the lens mount is fixed to the photographing apparatus, the ring-shaped movable member is closer to an image-taking-surface side of the photographing apparatus than the fixing member, the force application member is closer to the image-taking-surface side than the movable member, and when the movable member rotates in a first direction of the rotation direction, the movable member slides along the included surface and moves towards the image-taking-surface side, and the second protrusion portion presses the first protrusion portion towards the image-taking-surface side, thereby fixing the interchangeable lens to the photographing apparatus.

In addition, the above summary does not enumerate all the essential features of the present disclosure. Moreover, sub-combinations of these feature groups may also constitute inventions.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some exemplary embodiments of the present disclosure, and a person of ordinary skill in the art may still derive other drawings from these accompanying drawings without creative efforts.

FIG. 1 is a front perspective view of a photographing apparatus from an image-taking-surface side according to some exemplary embodiments of the present disclosure;

FIG. 2 is a back perspective view of the photographing apparatus from the opposite side of the image-taking-surface side according to some exemplary embodiments of the present disclosure;

FIG. 3 is an exemplary block diagram illustrating the functions of the photographing apparatus according to some exemplary embodiments of the present disclosure;

FIG. 4 is a perspective view of an interchangeable lens viewed from a lens mount side according to some exemplary embodiments of the present disclosure;

FIG. 5A is a front exploded perspective view of the lens mount from the photographed object side of the photographing apparatus according to some exemplary embodiments of the present disclosure;

FIG. 5B is a back exploded perspective view of the lens mount from the image-taking-surface side of the photographing apparatus according to some exemplary embodiments of the present disclosure;

FIG. 6A is a front perspective view of a fixing member viewed from the image-taking-surface side according to some exemplary embodiments of the present disclosure;

FIG. 6B is an enlarged view of an enclosed section 430 in FIG. 6A according to some exemplary embodiments of the present disclosure;

FIG. 7A is a perspective view of a movable member viewed from the photographed object side according to some exemplary embodiments of the present disclosure;

FIG. 7B is an enlarged view of an enclosed section 530 in FIG. 7A according to some exemplary embodiments of the present disclosure;

FIG. 8A is a schematic cross-sectional view of an inclined surface of the fixing member and an inclined surface of the movable member according to some exemplary embodiments of the present disclosure;

FIG. 8B is a schematic cross-sectional view of the inclined surface of the fixing member and the inclined surface of the movable member according to some exemplary embodiments of the present disclosure;

FIG. 8C is a schematic cross-sectional view of the inclined surface of the fixing member and the inclined surface of the movable member according to some exemplary embodiments of the present disclosure;

FIG. 9A is a view of rotation of an operation member in a first direction with respect to the photographing apparatus according to some exemplary embodiments of the present disclosure;

FIG. 9B is a view of the cross-section A-A′ of FIG. 9A according to some exemplary embodiments of the present disclosure;

FIG. 10A is a view of the rotation of the operation member in the first direction with respect to the photographing apparatus according to some exemplary embodiments of the present disclosure;

FIG. 10B is a view of the cross-section A-A′ of FIG. 10A according to some exemplary embodiments of the present disclosure;

FIG. 11A is a view of the rotation of the operation member in the first direction with respect to the photographing apparatus according to some exemplary embodiments of the present disclosure;

FIG. 11B is a view of the cross-section A-A′ of FIG. 11A according to some exemplary embodiments of the present disclosure;

FIG. 12 is a perspective view of a state in which the movable member is embedded into the fixing member according to some exemplary embodiments of the present disclosure;

FIG. 13A is an enlarged view of an enclosed section 540 in FIG. 12 according to some exemplary embodiments of the present disclosure;

FIG. 13B is a view of the enclosed section 540 in FIG. 12 when the movable member rotates in the first direction according to some exemplary embodiments of the present disclosure;

FIG. 13C is a view the enclosed section 540 in FIG. 12 when the movable member rotates in the first direction according to some exemplary embodiments of the present disclosure; and

FIG. 14 is a view of an unmanned aircraft and a remote operation device according to some exemplary embodiments of the present disclosure.

### DETAILED DESCRIPTION

The following describes some exemplary embodiments using implementations of the present disclosure. However, the following implementations do not limit the exemplary embodiments related to the claims. In addition, all combinations of features described in the implementations may not be necessary for the solutions of the disclosure.

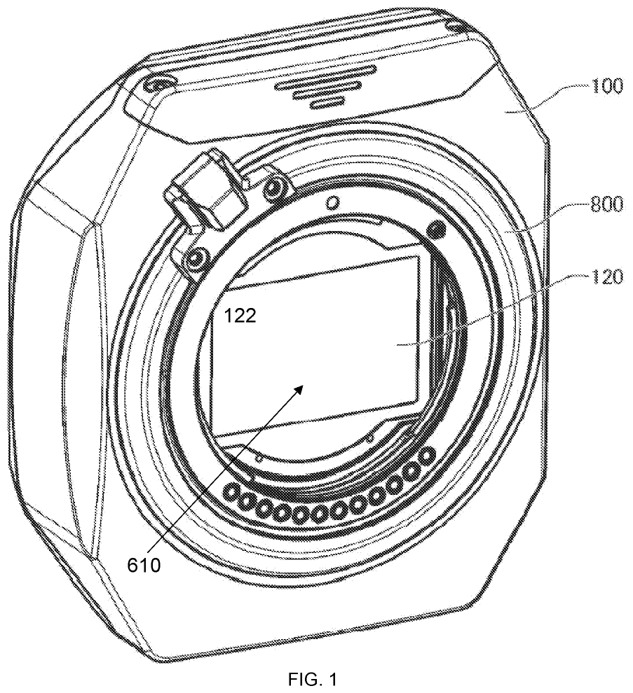

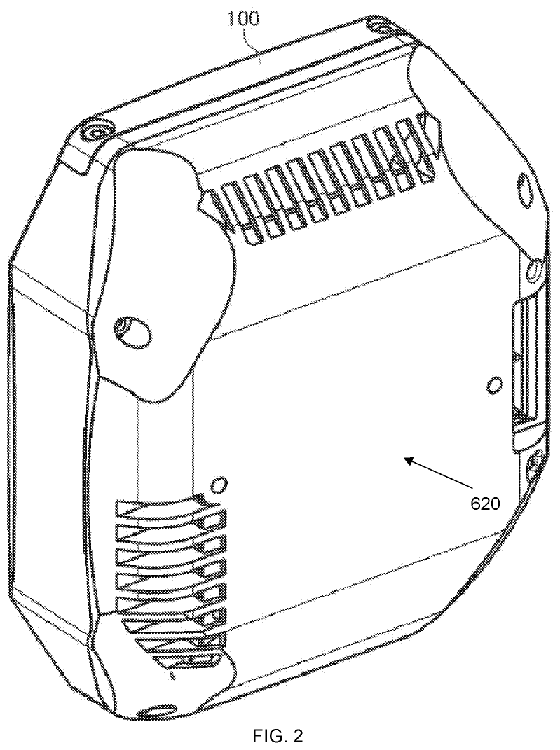

FIG. 1 is a front perspective view of a photographing apparatus 100 as viewed from an image-taking-surface side 610 according to some exemplary embodiments of the present disclosure. FIG. 2 is a back perspective view of external appearance viewed from the opposite side 620 of the image-taking-surface side 610 of the photographing apparatus 100 according to some exemplary embodiments of the present disclosure. The photographing apparatus 100 includes an image sensor 120 and a lens mount 800 for detachably connecting an interchangeable lens to the photographing apparatus 100. The photographing apparatus 100, with the interchangeable lens mounted thereon, may be supported by a support device for adjusting an attitude of the photographing apparatus 100. The photographing apparatus 100 may be mounted on a movable object. The photographing apparatus 100 may be mounted on the movable object via the support device. A non-limiting exemplary movable object may be an object movable in the air, a vehicle movable on the ground, a ship movable on the water, or the like. The object movable in the air, in addition to an unmanned aerial vehicle (UAV), may further includes another aerial vehicle movable in the air, an airship, a helicopter, or the like.

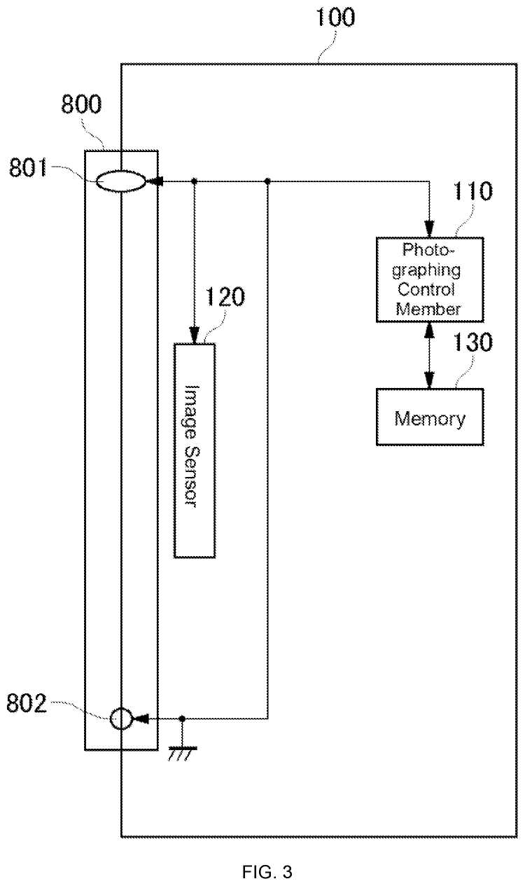

FIG. 3 is an exemplary block diagram illustrating the functions of the photographing apparatus 100 according to some exemplary embodiments of the present disclosure. The photographing apparatus 100 may include a photographing control member 110, an image sensor 120, a memory 130, and a lens mount 800. The image sensor 120 may include a CCD or a CMOS having an image-taking-surface 122 (shown in FIG. 1). The image sensor 120 captures an optical image formed by the interchangeable lens, and outputs the captured image to the photographing control member 110. The photographing control member 110 may include a microprocessor such as a CPU or an MPU, and a microcontroller such as an MCU. The photographing control member 110 may control the photographing apparatus 100 according to an operation command of the photographing apparatus 100.

The memory 130 may be a computer-readable recording medium, and may include at least one of flash memories such as an SRAM, a DRAM, an EPROM, an EEPROM, a USB memory, and a solid-state drive (SSD). The memory 130 may store a program necessary for the photographing control member 110 to control the image sensor 120, and the like. The memory 130 may be disposed inside a housing of the photographing apparatus 100. The memory 130 may be configured to be detachably connected to the housing of the photographing apparatus 100.

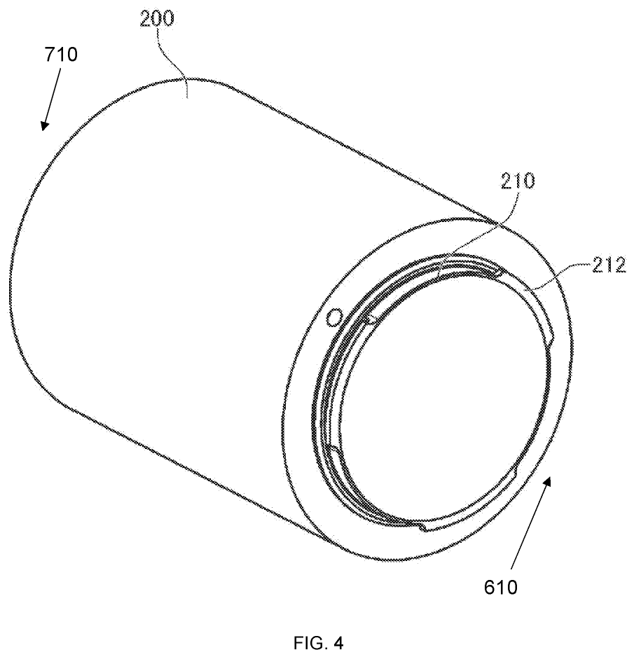

The lens mount 800 has a mechanical structure for detachably connecting the interchangeable lens to the photographing apparatus 100. The lens mount 800 may be disposed at a position opposite to the image-taking-surface side 610 of the image sensor 120. The lens mount 800 may include a locking pin 801 and an electrical contact 802. The locking pin 801 may be configured to apply a force to the photographed object side by using an elastic object such as a spring. The interchangeable lens may rotate while pressing the locking pin 801 to the image-taking-surface side. When the interchangeable lens rotates to a predetermined position, the locking pin 801 may be embedded in an insertion hole for positioning the interchangeable lens, and the interchangeable lens may be locked to the photographing apparatus 100. In addition, when the interchangeable lens rotates to the predetermined position, the electrical contact 802 may be electrically connected to an electrical contact of the interchangeable lens. The photographed object may be a person or a landscape photographed by the photographing apparatus 100. The photographed object side 710 (shown in FIG. 4) may refer to a side opposite to the image-taking-surface side 610, the front side of the photographing apparatus 100, the side of a space in which an object photographed by the photographing apparatus 100 exists, or the like.

FIG. 4 is a perspective view of an interchangeable lens 200 viewed from the side of a lens mount 210 according to some exemplary embodiments of the present disclosure. The lens mount 210 on the interchangeable lens 200 side has a plurality of protrusion portions 212 protruding outwards along an outer circumference.

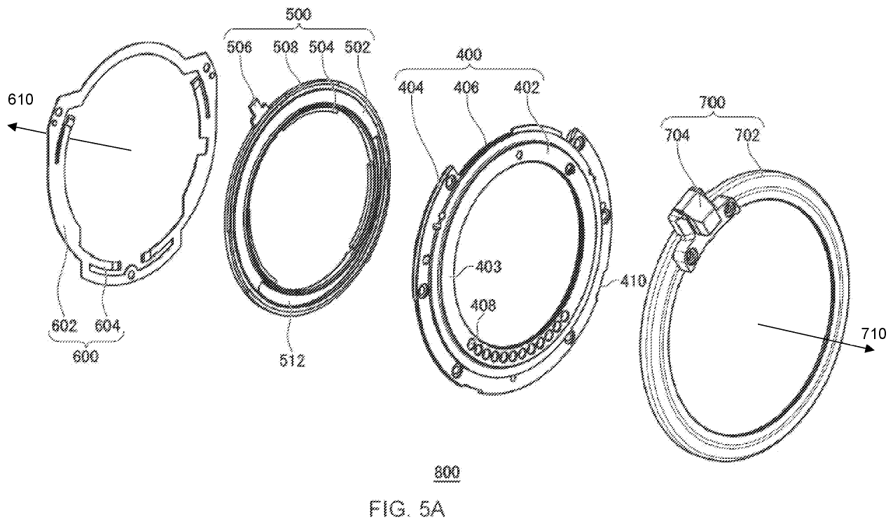

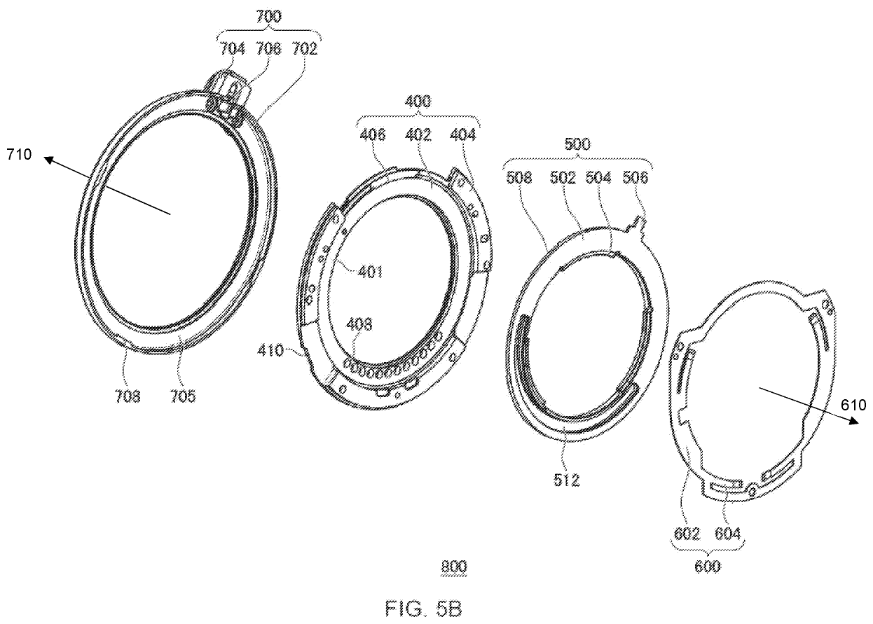

FIG. 5A is a front exploded perspective view of the lens mount 800 from the photographed object side 710 of the photographing apparatus 100 according to some exemplary embodiments of the present disclosure. FIG. 5B is a back exploded perspective view of the lens mount 800 from the image-taking-surface side 610 of the photographing apparatus 100 according to some exemplary embodiments of the present disclosure.

The lens mount 800 may include a ring-shaped fixing member 400, a ring-shaped movable member 500, a ring-shaped force application member 600, and a ring-shaped operation member 700. The fixing member 400 may be fixed to the photographing apparatus 100. The fixing member 400 may be fixed to the housing of the photographing apparatus 100. The fixing member 400 may be fixed to a surface on the front side of the housing of the photographing apparatus 100. The fixing member 400 may have a ring-shaped portion 402 and a flange portion 404. The ring-shaped portion 402 may have a surface 401 on the image-taking-surface side and a surface 403 on the photographed object side. The surface 401 is a non-limiting example of a first surface. The ring-shaped portion 402 may have a plurality of through holes 408 for arranging a plurality of electrical contacts 802 to be electrically connected to a plurality of electrical contacts of the interchangeable lens 200. The flange portion 404 on an outer side of the ring-shaped portion 402 protrudes further towards the image-taking-surface side than the ring-shaped portion 402. The fixing member 400 may be fixed to the photographing apparatus 100 via the flange portion 404. The fixing member 400 may be screwed to the housing of the photographing apparatus 100 via the flange portion 404. In addition, a non-limiting example of “member” may be a structural element including materials and plates.

The movable member 500 may be configured to be closer to the image-taking-surface side than the fixing member 400, and may be capable of rotating while in contact with the fixing member 400. The movable member 500 may have a protrusion portion 504 engaged with the protrusion portion 212 of the interchangeable lens 200. The movable member 500 may have a plurality of protrusion portions 504 protruding inwards on an inner circumference. The movable member 500 may have an arc-shaped through groove 512 at a position opposite to the through hole 408. The movable member 500 may have an attachment portion 506 that protrudes outwards on an outer circumference and may be fixed to the operation member 700. The movable member 500 may be rotatably configured with respect to the fixing member 400.

The force application member 600 may be configured to be closer to the image-taking-surface side than the movable member 500, and may apply a force to the movable member 500 towards the fixing member 400. The force application member 600 may rotatably push the movable member 500 with respect to the fixing member 400 and movably along a direction of an optical axis of the photographing apparatus 100. The force application member 600 may sandwich the movable member 500 to be fixed to the flange portion 404. The force application member 600 may be threaded to the flange portion 404. The force application member 600 may have a plurality of leaf springs 604 on an inner circumference. The plurality of leaf springs 604 may be arranged in an arc shape. The plurality of leaf springs 604 may press the movable member 500 towards the surface 401 of the ring-shaped portion 402.

The operation member 700 may be configured to be closer to the photographed object side than the fixing member 400, and may be fixed to the movable member 500 via the fixing member 400. The operation member 700 may have a ring-shaped portion 702 and a rod 704 protruding outwards from an outer circumference of the ring-shaped portion 702. A user may operate the rod 704 to cause the movable member 500 and the operation member 700 to rotate with respect to the fixing member 400. The rod 704 may have a groove 706 for arranging the attachment portion 506 of the movable member 500 on the image-taking-surface side. The attachment portion 506 may be embedded in the groove 706 and fixed. Therefore, the operation member 700 may rotate together with the movable member 500 with respect to the fixing member 400. The ring-shaped portion 702 may have a ring-shaped groove 705 on the image-taking-surface side. The operation member 700 may have a plurality of protrusion portions 708 protruding inwards on a side wall of the groove 705. The fixing member 400 may have a notch portion 410 corresponding to the protrusion portion 708 on an outer peripheral surface of the flange portion 404. The protrusion portion 708 of the operation member 700 may be embedded in the fixing member 400 through the opening portion 410. The protrusion portion 708 may be engaged with a surface on the side of the image-taking-surface side of the flange portion 404, to prevent the operation member 700 from being detached from the fixing member 400.

In the lens mount 800 constructed as described above, the movable member 500 may be caused to rotate with respect to the fixing member 400, the protrusion portion 504 of the movable member 500 may be engaged with the protrusion portion 212 of the interchangeable lens 200.

The fixing member 400 may have an inclined surface 406 on the surface 401 in contact with the movable member 500, where the inclined surface 406 may have an angle with respect to a rotation direction of the movable member 500. The movable member 500 may have an inclined surface 508 on the surface 502 in contact with the fixing member 400, where the inclined surface 508 may have an angle with respect to a rotation direction of the fixing member 400.

As a result, the movable member 500 may move towards the side of the image-taking-surface 122 while rotating in a first direction along the inclined surface 406 and the inclined surface 508. The protrusion portion 504 of the movable member 500 may press the protrusion portion 212 of the interchangeable lens 200 to the side of the image-taking-surface 122 (i.e., the image-taking-surface side 610), to fix the interchangeable lens 200 to the photographing apparatus 100.

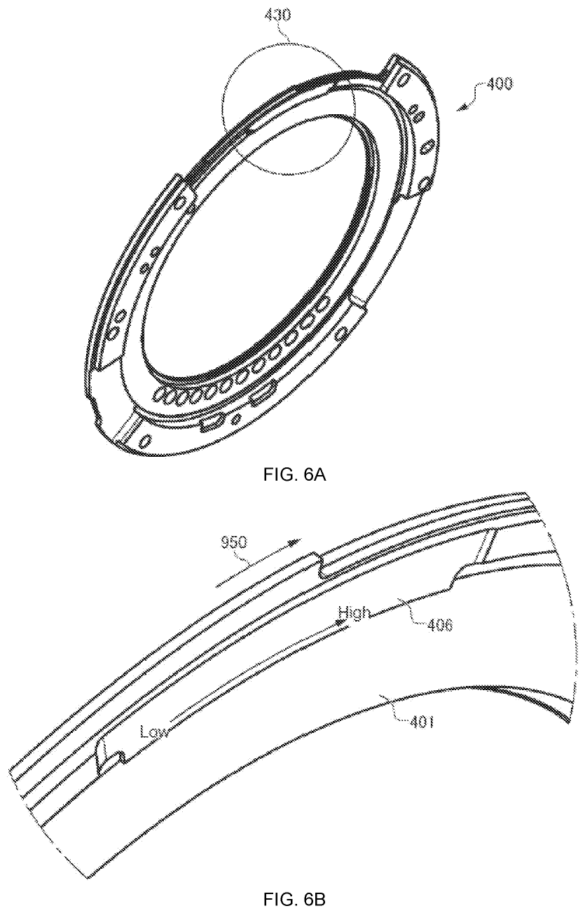

FIG. 6A is a front perspective view of the fixing member 400 viewed from the image-taking-surface side according to some exemplary embodiments of the present disclosure. FIG. 6B is an enlarged view of an enclosed section 430 in FIG. 6A. The fixing member 400 may have an inclined surface 406 that gradually rises towards the image-taking-surface side 610 with respect to a first direction 950 in which the movable member 500 rotates. The fixing member 400 may have a plurality of arc-shaped inclined surfaces 406 on the surface 401. The plurality of inclined surfaces 406 may be formed along a circumference of the fixing member 400.

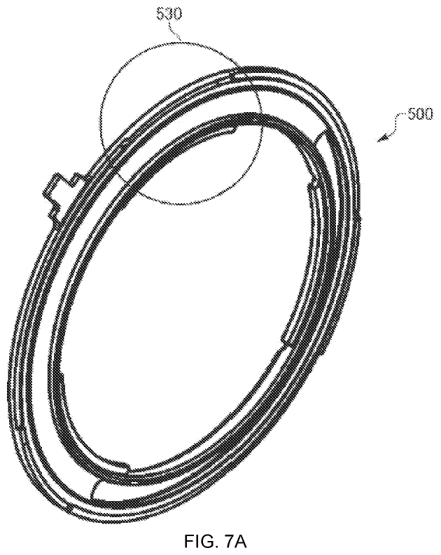

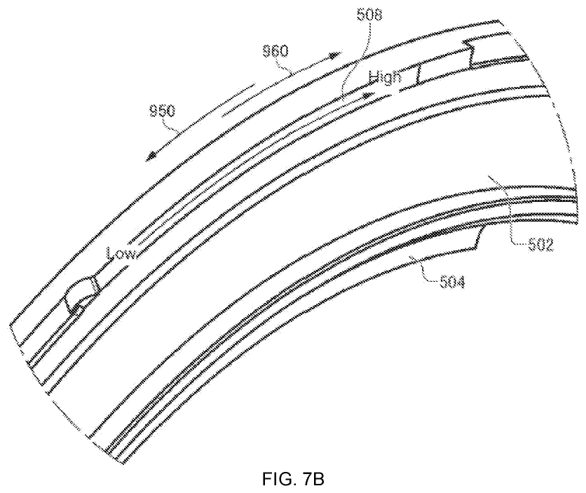

FIG. 7A is a perspective view of the movable member 500 viewed from the photographed object side according to some exemplary embodiments of the present disclosure. FIG. 7B is an enlarged view of an enclosed section 530 in FIG. 7A. The movable member 500 may have an inclined surface 508 on the surface 502 facing the fixing member 400, where the inclined surface 508 gradually rises towards the side of the photographed object with respect to a second direction 960 opposite to the first direction 950 in which the movable member 500 may rotate. The movable member 500 may have a plurality of arc-shaped inclined surfaces 508 on the surface 502. The plurality of inclined surfaces 508 may be formed along a circumference of the movable member 500.

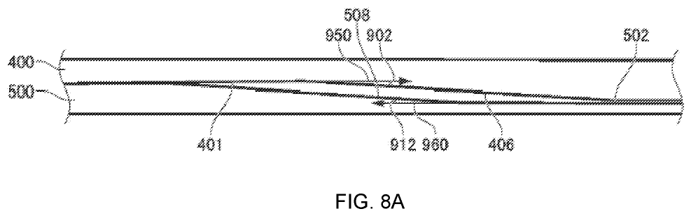

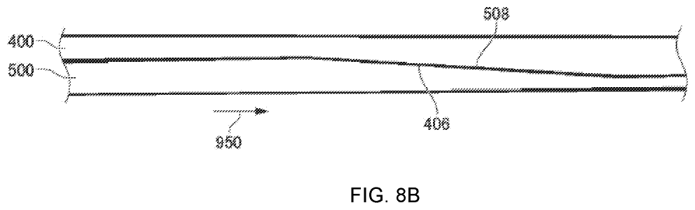

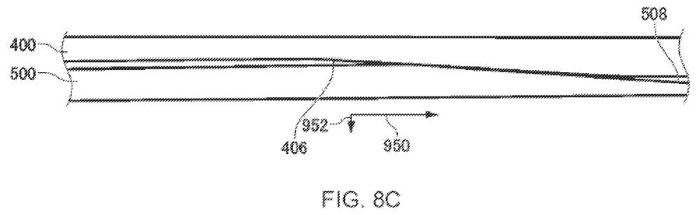

FIG. 8A is a schematic cross-sectional view of an inclined surface of the fixing member and an inclined surface of the movable member according to some exemplary embodiments of the present disclosure; FIG. 8B is a schematic cross-sectional view of the inclined surface of the fixing member and the inclined surface of the movable member according to some exemplary embodiments of the present disclosure; and FIG. 8C is a schematic cross-sectional view of the inclined surface of the fixing member and the inclined surface of the movable member according to some exemplary embodiments of the present disclosure. The fixing member may have an inclined surface 406 on the surface 401. The inclined surface may be inclined along a direction having an acute angle 902 on the image-taking-surface side with respect to the first direction 950 when viewed from a side of a side surface. The movable member 500 may have an inclined surface 508 on the surface 502. The inclined surface may be inclined along a direction having an acute angle 912 on the side of the photographed object with respect to the second direction 960 opposite to the first direction 950 when viewed from a side of a side surface.

As shown in FIG. 8A, when the movable member 500 rotates in the first direction 950 with respect to the fixing member 400, the inclined surface 508 is in contact with the inclined surface 406, as shown in FIG. 8B. In addition, when the movable member 500 rotates in the first direction 950 with respect to the fixing member 400, as shown in FIG. 8C, the inclined surface 508 slides on the inclined surface 406. As a result, the movable member 500 moves along a third direction 952 towards the image-taking-surface side while rotating in the first direction 950 with respect to the fixing member 400. Therefore, the protrusion portion 504 of the movable member 500 presses the protrusion portion 212 of the interchangeable lens 200 towards the image-taking-surface side, to fix the interchangeable lens 200 to the photographing apparatus 100.

In addition, in some exemplary embodiments, both the fixing member 400 and the movable member 500 have an inclined surface. However, at least one of the fixing member 400 and the movable member 500 may have an inclined surface. When one of the fixing member 400 and the movable member 500 has an inclined surface, the other one of the fixing member 400 and the movable member 500 may have a protrusion capable of causing the inclined surface to slide at a position facing the inclined surface.

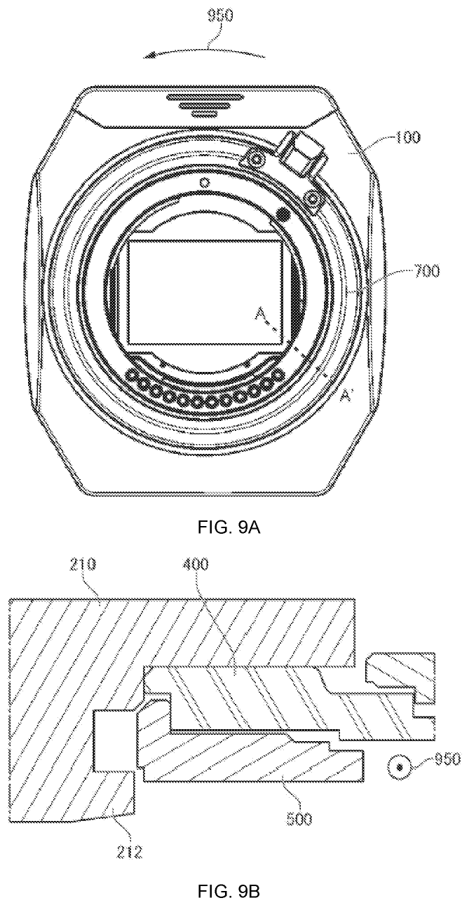

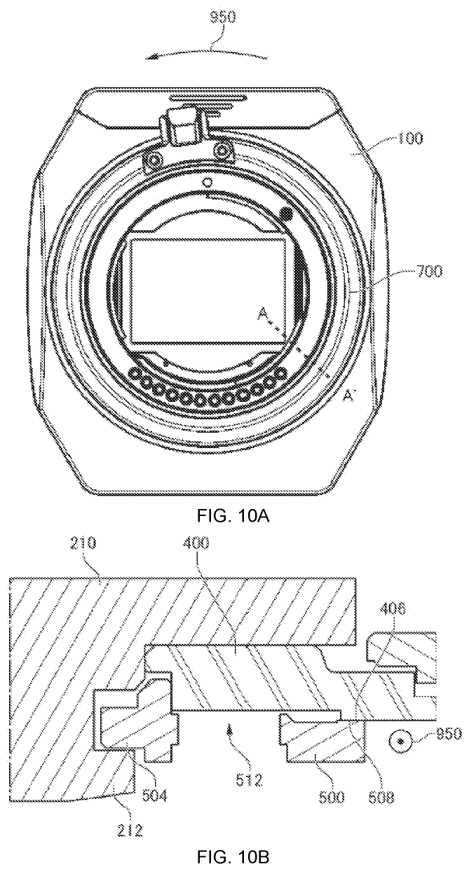

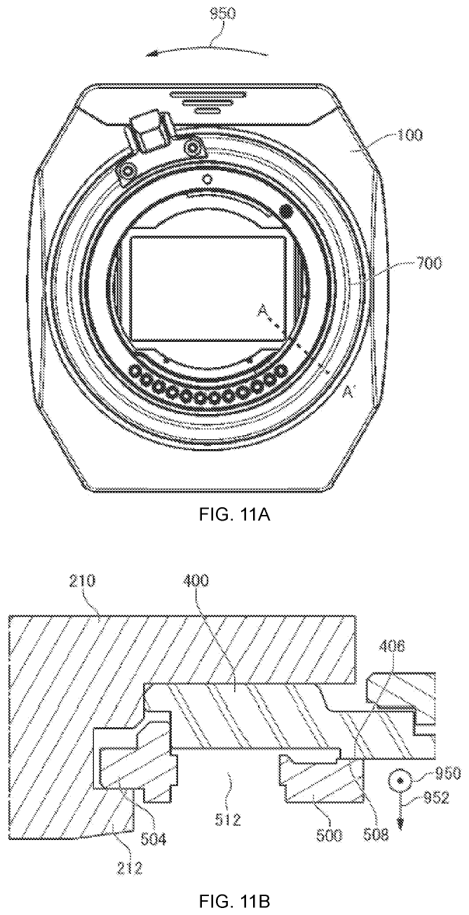

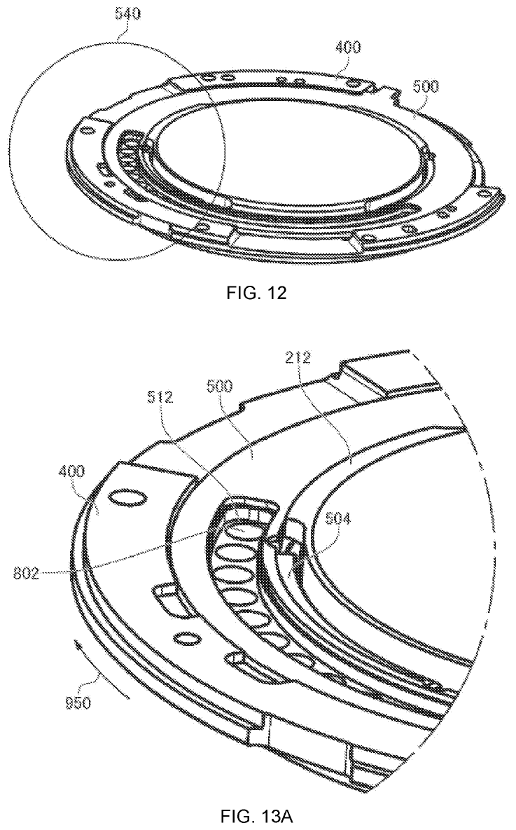

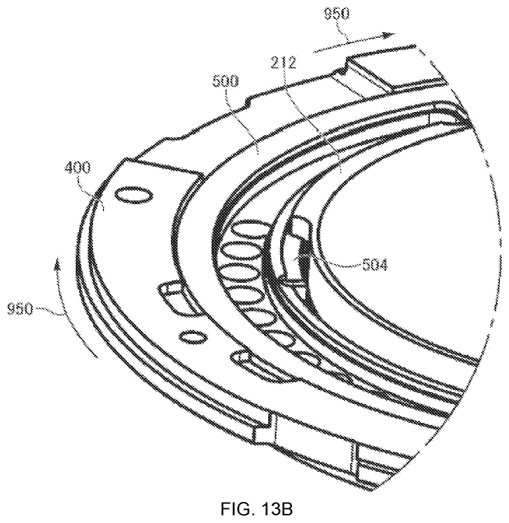

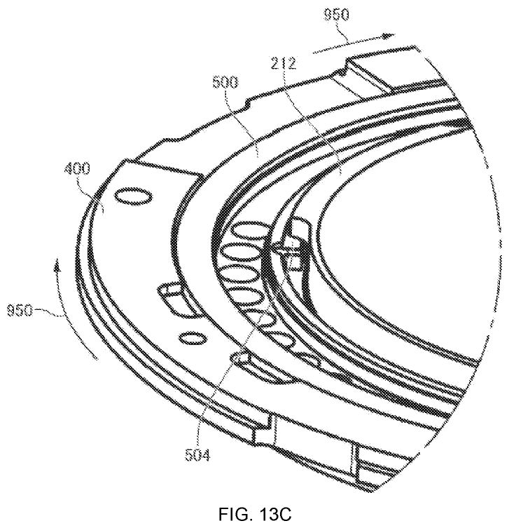

FIG. 9A, FIG. 10A, and FIG. 11A each shows the rotation of the operation member 700 in the first direction 950 with respect to the photographing apparatus 100, according to some exemplary embodiments of the present disclosure. FIG. 9B, FIG. 10B, and FIG. 11B show cross-sections A-A′ in FIG. 9A, FIG. 10A, and FIG. 11A, respectively. FIG. 12 is a perspective view of a state in which the movable member 500 is embedded into the fixing member 400 according to some exemplary embodiments of the present disclosure. FIG. 13A is an enlarged view of an enclosed section 540 in FIG. 12 according to some exemplary embodiments of the present disclosure. FIG. 13B and FIG. 13C each show a case in which the movable member 500 rotates along the first direction 950 according to some exemplary embodiments of the present disclosure.

In the states shown in FIG. 9A, FIG. 9B, and FIG. 13A, a state in which the operation member 700 and the movable member 500 have not rotated with respect to the fixing member 400, and the interchangeable lens 200 is embedded in the lens mount 800, but the protrusion portion 212 of the interchangeable lens 200 has not been engaged with the protrusion portion 504 of the movable member 500 is shown. In this state, the movable member 500 rotates in the first direction 950 with respect to the fixing member 400 (in FIG. 9B, with respect to a direction of a paper surface towards the front). FIG. 10A, FIG. 10B, and FIG. 13B each shows a state in which the operation member 700 and the movable member 500 rotate with respect to the fixing member 400, and the protrusion portion 212 of the interchangeable lens 200 is engaged with the protrusion portion 504 of the movable member 500. In the states in FIG. 10A, FIG. 10B, and FIG. 13B, the protrusion portion 504 of the movable member 500 is in a state in which the protrusion portion 212 of the interchangeable lens 200 has not been pressed to the image-taking-surface side.

FIG. 11A, FIG. 11B, and FIG. 13C each shows a state in which the operation member 700 and the movable member 500 further rotate with respect to the fixing member 400 from the states in FIG. 10A, FIG. 10B, and FIG. 13B. In this state, the inclined surface 508 of the movable member 500 slides on the inclined surface 406 of the fixing member 400, and the movable member 500 moves along the third direction 952 on the image-taking-surface side. In this way, in the states in FIG. 11A, FIG. 11B, and FIG. 13C, the protrusion portion 212 of the interchangeable lens 200 is engaged with the protrusion portion 504 of the movable member 500, and the protrusion portion 504 of the movable member 500 presses the protrusion portion 212 of the interchangeable lens 200 along the third direction 952. In this way, the interchangeable lens 200 may be pressed and fixed to the image-taking-surface side of the photographing apparatus 100.

As a mechanical structure that helps the movable member 500 to move to the image-taking-surface side at the same time when the movable member 500 rotates with respect to the fixing member 400, it is conceivable to provide threads on each of the fixing member 400 and the movable member 500. In other words, the fixing member 400 and the moveable member may include threads, thereby forming a mechanical structure. The mechanical structure may be configured to cause the moveable member 500 moving towards the image-taking-surface side while the movable member 500 rotates with respect to the fixing member 400. In this form, as the movable member 500 rotates with respect to the fixing member 400, the movable member 500 moves towards the image-taking-surface side along the thread. In this structure, to cause the movable member 500 to move towards the image-taking-surface side by a particular distance, and to form the threads, some thicknesses may present in an optical axis direction of both the fixing member 400 and the movable member 500. Due to the thicknesses, a flange distance indicating a distance from a lens mounting surface to the image-taking-surface side becomes longer. In addition, when the threads are formed in an outer peripheral member of the movable member 500 and the threads corresponding to the threads of the movable member 500 are formed in the fixing member 400, the fixing member 400 has a structure surrounding the outer peripheral member of the movable member 500, and the threads may be formed on the inner wall of the structure. This structure may be disposed on the fixing member 400, to increase the outer diameter of the fixing member 400. That is, a size of the lens mount 800 increases.

In some exemplary embodiments according to the present disclosure, in lens mount 800, an inclined surface only needs to be formed on an opposite surface of at least one of the fixing member 400 and the movable member 500, where the inclined surface moves towards the side of the image-taking-surface side while the movable member 500 rotates. Therefore, compared with a structure used for forming threads, this embodiment can reduce the flange distance and miniaturize the lens mount 800.

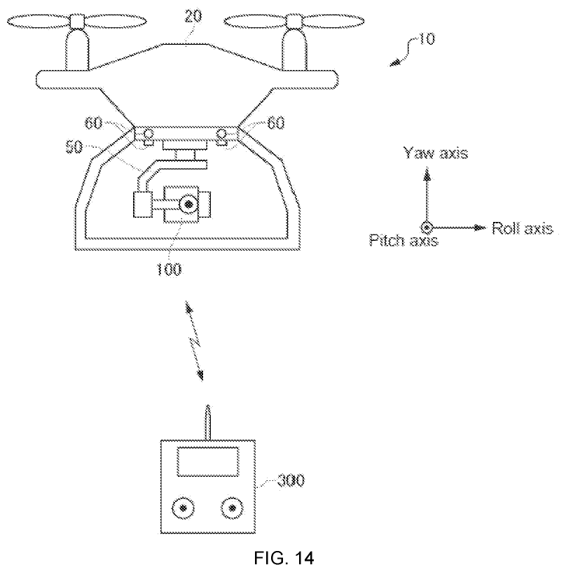

The photographing apparatus 100 may be mounted on a movable object. The photographing apparatus 100 may alternatively be mounted on a UAV shown in FIG. 14, according to some exemplary embodiments of the present disclosure. A UAV 10 may have a UAV main body 20, a gimbal 50, a plurality of photographing devices 60, and a photographing apparatus 100. The gimbal 50 and the photographing apparatus 100 may be some non-limiting examples of a photographing system. The UAV 10 may be a non-limiting example of a movable object propelled by a propulsion member. A non-limiting exemplary movable object may be a flying object such as an airplane movable in the air, a vehicle movable on the ground, a ship movable on the water, or the like, in addition to the UAV.

The UAV main body 20 may have a plurality of propellers. The plurality of propellers is a non-limiting example of the propulsion member. The UAV main body 20 may control the plurality of propellers to rotate, so that the UAV 10 may fly. In some exemplary embodiments according to the present disclosure, the UAV main body 20 uses, four propellers to enable UAV 10 to fly. Any number(s) of the propellers may be used. In addition, the UAV 10 may alternatively be a fixed-wing aircraft without any propellers.

The photographing apparatus 100 may be a camera for photographing a to-be-photographed object included in a desired camera range. A non-limiting example of a support device may be a gimbal 50. The gimbal 50 rotatably supports the photographing apparatus 100. In some exemplary embodiments according to the present disclosure, the gimbal 50 uses an actuator to rotatably support the photographing apparatus 100 with a pitch axis. The gimbal 50 uses the actuator to further rotatably support the photographing apparatus 100 with a roll axis and a yaw axis as centers. The gimbal 50 can change an attitude of the photographing apparatus 100 by causing the photographing apparatus 100 to rotate with respect to at least one of the yaw axis, the pitch axis, or the roll axis as a center of rotation.

The plurality of photographing devices 60 may be sensing cameras that photograph surroundings of the UAV 10 to aid the control the flight of the UAV 10. In some exemplary embodiments according to the present disclosure, two photographing devices 60 may be arranged on a nose of the UAV 10, that is, on the front side. In addition, the other two photographing devices 60 may be arranged on a bottom surface of the UAV 10. The two photographing devices 60 on the front side may be paired to function as stereo cameras. The two photographing devices 60 on the bottom surface may also be paired to function as stereo cameras. Perspective special data around the UAV 10 may be generated based on images captured by the plurality of photographing devices 60. The number of photographic apparatuses 60 of the UAV 10 is not limited to four. Any number(s) of the photographing devices 60 of the UAV 10 may be used. In some exemplary embodiments of the present disclosure, the UAV 10 may have at least one photographing device 60. Alternatively, the UAV 10 may have at least one photographing device 60 on each of the nose, a tail, a side surface, a bottom surface, and a top surface of the UAV 10. A viewing angle that can be set in the photographing device 60 may be greater than a viewing angle that can be set in the photographing apparatus 100. The photographing device 60 may have a single focus lens or a fisheye lens.

The remote operation device 300 may communicate with the UAV 10 to remotely operate the UAV 10. The remote operation device 300 may perform wireless communication with the UAV 10. The remote operation device 300 sends, to the UAV 10, indication information of various instructions related to movement of the UAV 10 such as ascending, descending, accelerating, decelerating, moving forward, moving backward, and rotating. The non-limiting exemplary indication information may include indication information causing the UAV 10 to ascend. The indication information may indicate a height at which the UAV 10 needs to be located. The UAV 10 moves to be located at the height indicated by the indication information received from the remote operation device 300. The indication information may include an ascending instruction to raise the UAV 10. The UAV 10 ascends after receiving the ascending instruction. When the flight height of the UAV 10 has reached an upper limit height, ascending of the UAV 10 may be limited even if the ascending instruction is received.

The exemplary embodiments according to the present disclosure described above by using the implementations. However, the technical scope of the exemplary embodiments according to the present disclosure is not limited to the scope described in the foregoing implementations. Apparently, a person of ordinary skill in the art can make various changes or improvements to the implementations. It is apparent from the description of the claims that all manners to which such changes or improvements are made can be included within the technical scope of the present invention.

It should be noted that the execution order of the actions, sequences, steps, and stages of the apparatuses, systems, programs, and methods in the claims, specification, and accompanying drawings of the specification can be implemented in any order, provided that there is no special statement such as “before . . . ” or “in advance”, and an output of previous processing is not used in subsequent processing. The operation procedures in the claims, specification, and accompanying drawings of the specification are described using “first” and “next” for convenience, but it does not mean that an implementation must be implemented in such an order.

### REFERENCE NUMERALS

10 UAV
20 UAV main body
50 Gimbal
60 Photographing device
100 Photographing apparatus
110 Photographing control member
120 Image sensor
130 Memory
200 Interchangeable lens
210 Lens mount
212 Protrusion portion
300 Remote operation device
400 Fixing member
402 Ring-shaped portion
404 Flange portion
406 Inclined surface
408 Through hole
410 Notch portion
500 Movable member
504 Protrusion portion
506 Attachment portion
508 Inclined surface
512 Through groove
600 Force application member
700 Operation member
702 Ring-shaped portion
704 Rod
708 Protrusion portion
800 Lens mount
801 Locking pin
802 Electrical contact
902 Acute angle
912 Acute angle
950 First direction
952 Third direction
960 Second direction

What is claimed is:

1. A lens mount for detachably connecting an interchangeable lens to a photographing apparatus, comprising:
a ring-shaped fixing member to fix to a photographing apparatus, including a first surface;
a ring-shaped movable member, including:
a second protrusion portion engageable with a first protrusion portion of an interchangeable lens, and
a second surface rotatably contacting the first surface; and
a force application member, applying a force to the movable member towards the fixing member, wherein
at least one of the first surface or the second surface includes an inclined surface having an angle with respect to a rotation direction of the movable member, and
when the lens mount is fixed to the photographing apparatus,
the ring-shaped movable member is closer to an image-taking-surface side of the photographing apparatus than the fixing member,
the force application member is closer to the image-taking-surface side than the movable member, and
when the movable member rotates in a first direction of the rotation direction, the movable member slides along the inclined surface and moves towards the image-taking-surface side, and the second protrusion portion presses the first protrusion portion towards the image-taking-surface side, thereby fixing the interchangeable lens to the photographing apparatus.

2. The lens mount according to claim 1, further comprising:
an operation member, fixed to the movable member and including a rod to control rotation of the movable member, wherein
the fixing member is sandwiched between the movable member and the operation member, and
when the lens mount is fixed to the photographic apparatus, the operation member is closer to a photographed object side than the fixing member.

3. The lens mount according to claim 1, wherein the first surface includes a first inclined surface facing towards the image-taking-surface side and inclining along a direction having an acute angle with respect to the first direction.

4. The lens mount according to claim 3, wherein the fixing member includes a plurality of first inclined surfaces on the first surface along a circumference of the fixing member.

5. The lens mount according to claim 1, wherein the second surface includes a second inclined surface facing towards a photographed object side and inclining along a direction having an acute angle with respect to a second direction opposite to the first direction.

6. The lens mount according to claim 5, wherein the movable member includes a plurality of second inclined surfaces on the second surface along a circumference of the movable member.

7. The lens mount according to claim 1, wherein the first surface includes a first inclined surface facing towards the image-taking-surface side and inclining along a direction having an acute angle with respect to the first direction; and
the second surface includes a second inclined surface facing towards the photographed object side and inclining along a direction having an acute angle with respect to a second direction opposite to the first direction.

8. The lens mount according to claim 7, wherein the fixing member includes a plurality of first inclined surfaces on the first surface along a circumference of the fixing member, and
the movable member includes a plurality of second inclined surfaces on the second surface along a circumference of the movable member.

9. The lens mount according to claim 8, wherein by rotating the movable member along the first direction with respect to the fixing member, and sliding the second inclined surface on the first inclined surface after the second included surface comes in contact with the first inclined surface, the movable member moves towards the image-taking-surface side.

10. The lens mount according to claim 1, wherein the first surface includes a ring-shaped portion on the image-taking-surface side;
the fixing member includes:
a flange portion, on an outer side of the ring-shaped portion and protruding further towards the image-taking-surface side than the ring-shaped portion, wherein
the force application member is fixed to the flange portion.

11. The lens mount according to claim 10, wherein the ring-shaped portion includes a through hole to allow an electrical connection between an electrical contact of the interchangeable lens and another electrical contact.

12. The lens mount according to claim 11, wherein the movable member has an arc-shaped through groove at a position opposite to the through hole.

13. A photographing system, comprising:
a photographing apparatus including an image sensor; and
a lens mount, including:
a ring-shaped fixing member fixed to the photographing apparatus, including a first surface,
a ring-shaped movable member, including:
a second protrusion portion engageable with a first protrusion portion of an interchangeable lens, and
a second surface rotatably contacting the first surface, and
a force application member, applying a force to the movable member towards the fixing member, wherein
at least one of the first surface or the second surface includes an inclined surface having an angle with respect to a rotation direction of the movable member, and
when the lens mount is fixed to the photographing apparatus,
the ring-shaped movable member is closer to an image-taking-surface side of the photographing apparatus than the fixing member,
the force application member is closer to the image-taking-surface side than the movable member, and
when the movable member rotates in a first direction of the rotation direction, the movable member slides along the included surface and moves towards the image-taking-surface side, and the second protrusion portion presses the first protrusion portion towards the image-taking-surface side, thereby fixing the interchangeable lens to the photographing apparatus.

14. The photographing system according to claim 13, further comprising:
a support device to support the photographing apparatus and to adjust an attitude of the photographing apparatus.

15. The photographing system according to claim 14, further comprising
a movable object, wherein the photographing apparatus is mounted on the movable object.

16. The photographing system according to claim 13, further comprising:
an operation member, fixed to the movable member and including a rod to control rotation of the movable member, wherein
the fixing member is sandwiched between the movable member and the operation member, and
when the lens mount is fixed to the photographic apparatus, the operation member is closer to a photographed object side than the fixing member.

17. The photographing system according to claim 13, wherein the first surface includes a first inclined surface facing towards the image-taking-surface side and inclining along a direction having an acute angle with respect to the first direction.

18. The photographing system according to claim 17, wherein the fixing member includes a plurality of first inclined surfaces on the first surface along a circumference of the fixing member.

19. The photographing system according to claim 13, wherein the second surface includes a second inclined surface facing towards a photographed object side and inclining along a direction having an acute angle with respect to a second direction opposite to the first direction.

20. The photographing system according to claim 19, wherein the movable member includes a plurality of second inclined surfaces on the second surface along a circumference of the movable member.
